(19) United States
(12) Patent Application Publication
(10) Pub. No.: US 2007/0094597 A1
(43) Pub. Date: Apr. 26, 2007

(54) DYNAMIC GRAPHICAL USER INTERFACE FOR A DESKTOP ENVIRONMENT

(76) Inventor: Mohamed A. Rostom, Calgary (CA)

Correspondence Address: DARBY & DARBY P.C., P. O. BOX 5257, NEW YORK, NY, 10150-5257, US

(21) Appl. No.: 11/566,126

(22) Filed: Dec. 1, 2006

Related U.S. Application Data
(63) Continuation-in-part of application No. 10/982,760, filed on Nov. 4, 2004.

(51) Int. Cl. G06F 3/00

(52) U.S. Cl. 715/700

(57) ABSTRACT

A method, system, and apparatus are directed to providing a graphical user interface over a network. A first selection of a button within a taskbar at a client is detected. A local menu of services is displayed in a display area that is visually independent of the taskbar. A second selection of a upload button displayed within the local menu is detected. In response, an upload of a file is enabled from the client to a directory on the server associated with one of a plurality of categories of services. A configuration of the local menu is received at the server. A request for a display of a menu at a client is also received. The menu is provided to the client over the network for display in a browser at the client based on the received configuration. The menu may include buttons for another plurality of categories of services.

### CROSS-REFERENCE TO RELATED APPLICATIONS

The present application is a Continuation In Part of patent application Ser. No. 10/982,760, entitled “DYNAMIC GRAPHICAL USER INTERFACE FOR A DESKTOP ENVIRONMENT” filed on Nov. 4, 2004, the benefit of the earlier filing date of which is hereby claimed under 35 U.S.C. § 120 and 37 C.F.R. 1.78, and which is further incorporated by reference.

### FIELD OF THE INVENTION

The present invention is directed to a graphic user interface (GUI), and more specifically to a GUI using a movable menu for accessing services of a computer desktop environment within a client or through a network to a remote server.

### BACKGROUND OF THE INVENTION

Current computer desktop GUIs typically include a desktop space where icons are displayed to represent programs, data, and other available software items. The desktop space is generally a large portion of a total display area, so there is room for a relatively large number of icons. Each icon is usually associated with an individual program or a specific feature of a program. To access further features and options of a program, a user generally must select and activate a corresponding icon, such as by double clicking on the icon, and then navigate to other options within the program.

Current desktop GUIs also typically provide a taskbar in the form of a relatively thin graphical strip located along an edge of the desktop environment. A user can select a graphical button, such as a START button, within the taskbar to navigate through a menu structure for access to programs, settings, and other software items. Taskbar navigation is generally performed through pop-up or drop-down menus that are visually connected to the taskbar, but extend beyond the boundaries of the taskbar. The pop-up or drop-down menus are needed, because the area of the taskbar is generally limited to the thin strip along one edge of a display. The pop-up or drop-down menus may be nested several layers deep. Each nested layer of the menu structure is typically displayed as a separate pop-up or drop-down menu in a rectangular image that is visually connected to a previous layer of the menu structure. Each nested layer also often includes small icons to represent a next layer or a software item. Many of the software items of the nested menus are accessible through an icon placed in the desktop space by the user. Thus, the desktop icons and the taskbar menus are somewhat duplicative.

Some GUIs are also emulated through a browser application to provide a desktop environment for interfacing with services of a networked server. Such network GUIs are sometimes referred to as Web operating systems. These network GUIs may appear similar to conventional client desktop GUIs. Some network GUIs may be customized by a user with short-cut icons on the desktop, quick-launch icons in a system tray, location of the task bar, background pattern, and other visual effects. These visual customizations are generally similar to those customizations that are possible with client desktop GUIs. However, customization of the client desktop environment and the network desktop environment is generally not coordinated.

### BRIEF DESCRIPTION OF THE DRAWINGS

FIG. 1 shows a functional block diagram of an exemplary computing device according to one embodiment of the invention;

FIG. 2 is a functional block diagram illustrating an overall architecture of an exemplary embodiment of the present invention;

FIG. 3 is a screen print illustrating a centrally circular menu in a desktop environment according to an exemplary embodiment of the present invention;

FIG. 4 is screen print illustrating circularly fanned tabs of software options associated with a selected icon in the exemplary desktop environment of FIG. 3;

FIG. 5 is a screen print illustrating a side curved menu in a desktop environment according to another exemplary embodiment of the present invention;

FIG. 6 is screen print illustrating elliptically fanned tabs of software options associated with a selected icon in the exemplary desktop environment of FIG. 5;

FIG. 7 is a flow diagram illustrating overall logic controlling interaction with a menu according to an exemplary embodiment of the invention;

FIGS. 8A and 8B are a flow diagram illustrating logic of a menu management process according to an exemplary embodiment of the invention;

FIG. 9 is a flow diagram illustrating logic of a shortcuts process according to an exemplary embodiment of the invention;

FIG. 10 shows components of an environment in which one or more embodiments of the invention may be practiced;

FIG. 11 is a flow diagram illustrating overall logic controlling interaction with a menu according to an exemplary embodiment of the invention;

FIG. 12 is a flow diagram illustrating overall logic for providing a user interface over a network;

FIGS. 13-15, 16A, and 16B show illustrative use cases for controlling interaction with a menu according to an exemplary embodiment of the invention;

FIGS. 17, 18A, 18B, and 19 show illustrative use cases for providing a user interface over a network; and

FIGS. 20-24 show illustrative use cases for controlling interaction with a menu according to another exemplary embodiment of the invention.

### DETAILED DESCRIPTION OF THE INVENTION

The present invention will now be described with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely software embodiment, an entirely hardware embodiment or an embodiment combining software and hardware aspects. The following detailed description is, therefore, not to be taken in a limiting sense.

Throughout the specification, the term “coupled,” or “in communication with” means a direct connection between the things that are connected, or an indirect connection through one or more either passive or active intermediary devices or components. The meaning of “a,” “an,” and “the” include plural references. The meaning of “in” includes “in” and “on.”

As used herein, the terms “drag”, “drop”, “drag-and-drop”, “dragging-and-dropping” refer to a process of a user selecting an icon or other visual representation of a file, directory, or the like, and moving the file from one visual location which represents a physical or logical location on a device to another visual location which represents another physical or logical location, wherein the use of the process indicates the file should be moved, copied, or otherwise transferred to the other physical or logical location.

Briefly stated, one aspect of the invention is direct to a method and system for providing a graphical user interface that enables dynamic access to various levels of software features and options through multiple icons that are provided over the entire desktop environment without limitation by a toolbar area.

Another aspect of the invention is directed to a method, system, and apparatus are directed for providing a graphical user interface over a network. A first selection of a button within a taskbar at a client is detected. A local menu of services is displayed in a display area that is visually independent of the taskbar. A second selection of a upload button displayed within the local menu is detected. In response, an upload of a file is enabled from the client to a directory on the server associated with one of a plurality of categories of services.

In another aspect, a configuration of the local menu is received at the server. A request for a display of a menu at a client is also received. The menu is provided to the client over the network for display in a browser at the client based on the received configuration. The menu may include buttons for another plurality of categories of services.

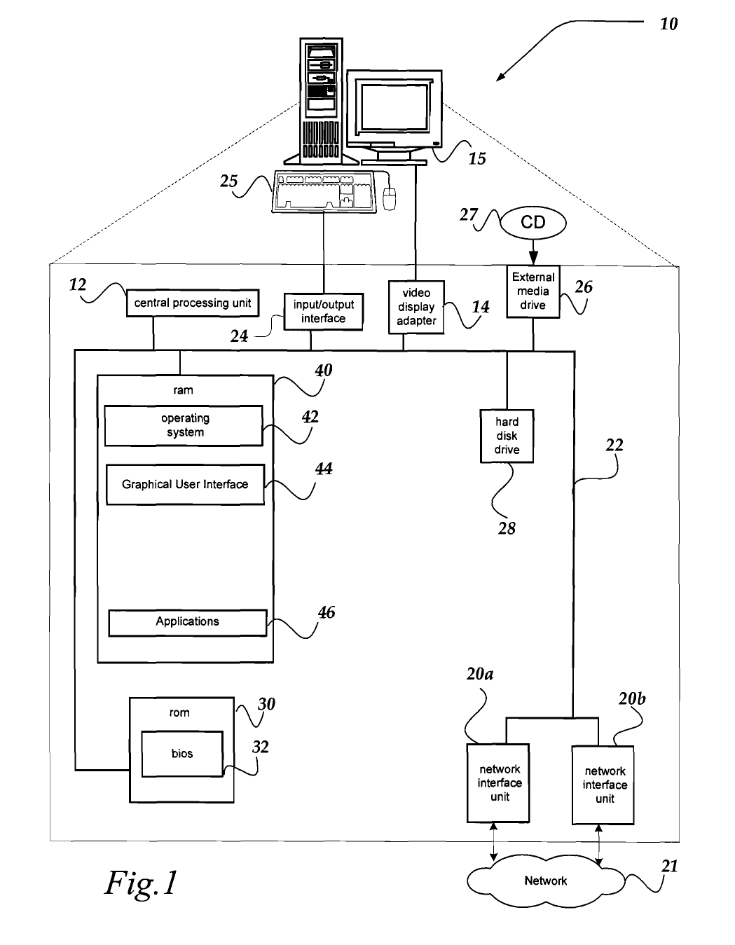

FIG. 1 shows a functional block diagram of an exemplary compute 10, according to one embodiment of the invention. Computer 10 may include many more components than those shown. The components shown, however, are sufficient to disclose an illustrative embodiment for practicing the invention. In an exemplary embodiment, computer 10 comprises a client device such as, but not limited to, personal computers (PCs), PDAs, mobile terminals (e.g., cell phones), servers, and the like.

Computer 10 includes a processing unit 12, a video display adapter 14 that can drive a display 15, and a mass memory, all in communication with each other via a bus 22. The mass memory generally includes RAM 40, ROM 30, and one or more permanent mass storage devices, such as an external media drive 26 that can read a machine readable medium such as a CD 27, a hard disk drive 28, a tape drive, and/or a floppy disk drive. The mass memory stores an operating system 42 for controlling the operation of computer 10. Any general-purpose operating system may be employed. A basic input/output system (“BIOS”) 32 is also provided for controlling low-level operation of computer 10.

The mass memory also includes computer-readable media, such as volatile, nonvolatile, removable, and non-removable media implemented in any method or technology for storage of information, such as computer readable instructions, data structures, program modules, or other data. Examples of computer-readable media include RAM, ROM, EEPROM, flash memory, or other memory technology, CD-ROM, digital versatile disks (DVD), or other optical storage, magnetic cassettes, magnetic tape, magnetic disk storage, or other magnetic storage devices, or any other medium which can be used to store the desired information and which can be accessed by a computing device.

The mass memory also stores program code and data. One or more applications 48 are loaded into mass memory and run on operating system 42. Examples of application programs include database programs, schedulers, transcoders, email programs, calendars, web services, word processing programs, spreadsheet programs, and so forth. Mass storage may further include applications such as a graphical user interface 44, which will be discussed in further detail below.

Computer 10 also includes input/output interface 24 for communicating with external devices, such as a keyboard, mouse, scanner, or other input devices 25. Computer 10 can communicate with the Internet, a telephone network, a postal network, or some other communications network via one or more network interfaces such as network interface units 20a and 20b, which are constructed for use with various communication protocols including transmission control protocol/Internet protocol (TCP/IP), user datagram protocol (UDP), code division multiple access (CDMA), time division multiple access (TDMA), global system for mobile communications (GSM), Institute for Electrical and Electronics Engineers (IEEE) 802.11, IEEE 802.16 (WiMax), SMS, general packet radio service (GPRS), Wireless Application Protocol (WAP), and the like. Network interface units 20a and 20b are sometimes known as transceivers, transceiving devices, network interface cards (NICs), and the like. The network interface units can facilitate communications between computing devices that conform to the same or differing communication protocols. For example, network interface units 20a and 20b are illustrated as communicating with a network 21, such as the Internet. Network 21 provides communication services for conforming server and/or client devices, such as a server.

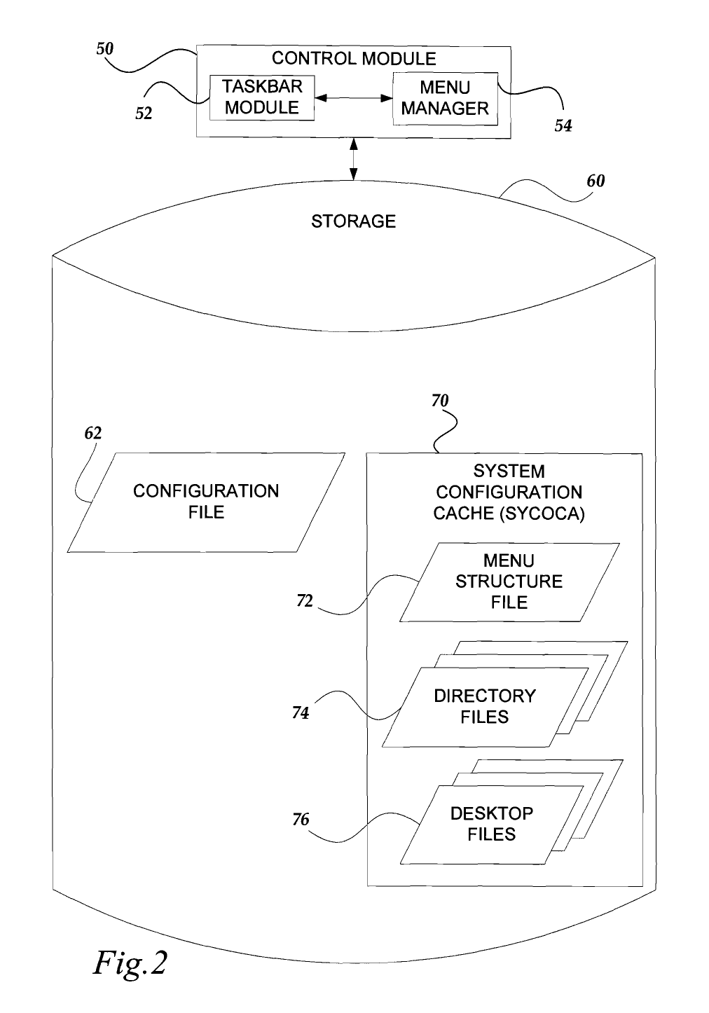

FIG. 2 is a functional block diagram illustrating an overall architecture of an exemplary embodiment of the present invention that provides a dynamic GUI. A control module 50 controls the GUI and communication with an operating system kernel. Operating system communication can be implemented in a conventional manner such as that used by a kicker module of the Linux™ based K Desktop Environment (KDE), and the like. Control module 50 includes a taskbar module 52 that provides desktop information and services through a graphical strip along one edge of a display. Some of the desktop information includes a clock and a system tray of small icons representing services that are running in the background. Other desktop information includes graphical tile buttons that represent currently running foreground services and enable a user to switch between windows of the foreground services.

A conventional taskbar also usually includes a small “Start” graphical button that enables a user to navigate a pop-up menu to a desired program or other service. These conventional pop-up menus usually remain visually tied to the small Start button in the taskbar and the pop-up menus are generally rectangular. The services available through a conventional taskbar pop-up menu are typically illustrated as small icons followed by a short title so as to minimize the display space taken up by the pop-up menu. The small icons and text can sometimes be difficult to read. Access to the services can also be duplicated with larger shortcut icons on a larger area of the desktop environment so that the user can quickly access a service without having to navigate through the pop-up menu. Multiple shortcut icons can clutter the desktop area, making it more difficult to use the desktop environment. The shortcut icons usually persist in the desktop area unless deleted from the desktop area.

Taskbar module 52 does not need to keep a pop-up menu visually tied to a start button in the taskbar. Instead, taskbar module 52 provides a menu activation button that enables a user to initiate a menu that is free from the taskbar and utilizes the larger area of the desktop. Larger shortcut icons need not be duplicated in the larger area of the desktop environment, although shortcut icons can still be used in the desktop environment. To initiate the menu, taskbar module 52 communicates a command to a menu manager 54, which displays and controls interaction with the menu.

Menu manager 54 communicates with a storage 60 that includes a configuration file 62 for storing screen location, graphic file names and/or address, color information, lighting information, and other visual data associated with menu elements to be displayed. Menu elements include a menu background, menu icons, submenu tabs, and other visual elements.

Each menu element has a unique identifier, sometimes referred to as a key. The key is used to associate a menu element with a portable network graphic (png) file (or other graphic file), with screen location coordinates, with lighting enhancements, and with other visual data. When menu elements move within the display area, changes to the location data and other visual data are stored relative to each corresponding key in configuration file 62.

Storage 60 also includes a system configuration cache (sycoca) 70, which stores functional information about the menu. Some of the menu elements comprise icons that are associated with a submenu or an application program (or other data service). The relationships between the icons and the submenus and/or services are defined by a menu structure file 72. An exemplary embodiment of menu structure file 72 is an extensible markup language (XML) file, which includes pointers that associate each icon (e.g., each icon key) with data for a corresponding submenu or with a service.

Data for a submenu is stored in a directory file 74. The data includes keys to identify tabs that will be displayed to visually illustrate the submenu. Each key is associated with a pointer to a png file that defines the graphical image of the tab. Similarly, each key can point to a string of text that will be displayed over the tab. Position, color, lighting, and other data for each tab can also be stored in the directory file, or in the configuration file.

Data for an application program, a data file, or other computing service is stored in a desktop file 76. A desktop file includes keys of those icons and submenu tabs that do not lead to further submenus, and instead are associated with executable code or other final data. Accordingly, desktop file 76 includes pointers to, and/or parameters for, corresponding programs, data files, or other services. Menu manager 54 can use this data to instruct an underlying operating system kernel to initiate a corresponding program, to access a data file, control a peripheral device, communicate through a network, and/or perform another service.

Screen Displays

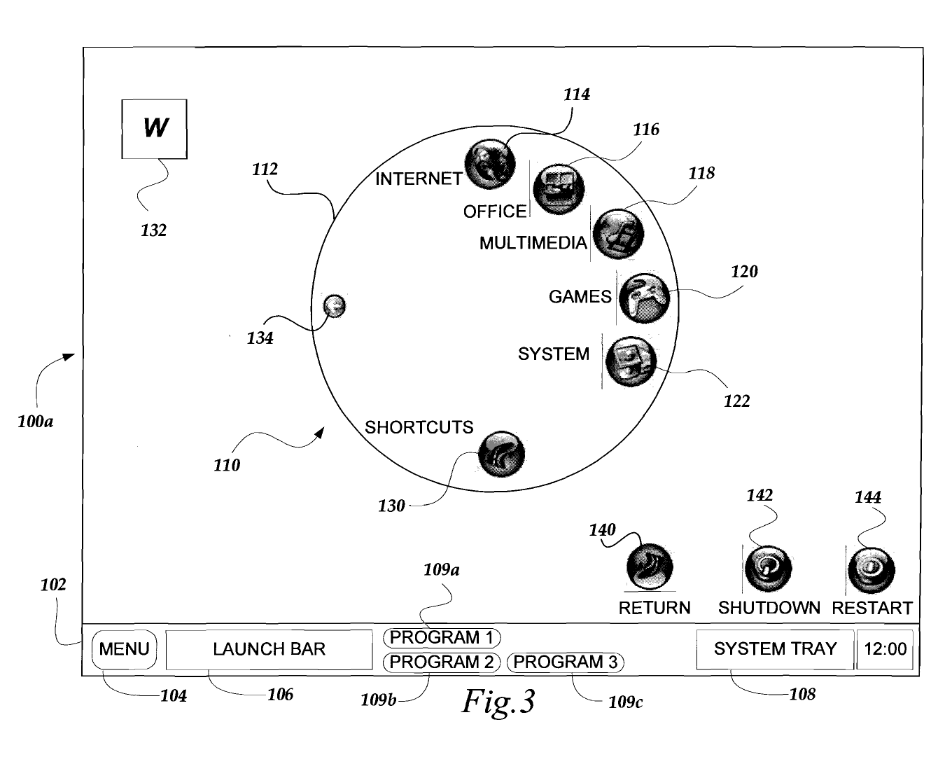

An example menu is shown in FIG. 3 as a centrally circular menu 110 in a desktop environment 100a according to an exemplary embodiment of the present invention. Centrally circular menu 110 is activated and displayed when a user left clicks on a menu activation button 104 within a taskbar 102. As indicated above, taskbar 102 can also include other elements such as a launch bar 106 of icons for immediately launching a program, and a system tray 108 identifying background services. The taskbar can further include tile buttons 109a-109c for minimizing, maximizing, and/or switching focus between foreground services such as application programs.

Centrally circular menu 110 comprises a number of menu elements, including a circular background area 112 that is displayed in a central portion of desktop environment 100a. Within circular background area 112 are a plurality of service icons 114-122. Each service icon represents a service or a submenu that leads to other services or additional submenus. Also within circular background area 112 are display control icons 130 and 134. A shortcuts control icon 130 enables a user to toggle display of shortcut icons, such as a shortcut icon 132, in the desktop area outside of circular background area 112. A menu location control icon 134 enables the user to move centrally circular menu 110 to another location in the display area. The menu can be moved to a left, right, top or bottom location. Alternatively, the menu can be dragged to any arbitrary location in the desktop environment.

Centrally circular menu 110 can also include one or more termination icons 140-144. Alternatively, the termination icons can be displayed separate from the menu as illustrated in FIG. 3. In yet another embodiment, the termination icons can be displayed in and controlled through the taskbar. In any case, a return icon 140 enables a user to terminate execution of the desktop GUI and return to an underlying operating system environment, such a command line operating system environment, a Microsoft Windows™ operating system environment, and the like. A shutdown icon 142 enables the user to terminate execution of the desktop GUI and power down the computing device. A restart icon 144 enables the user to terminate and restart execution of the desktop GUI.

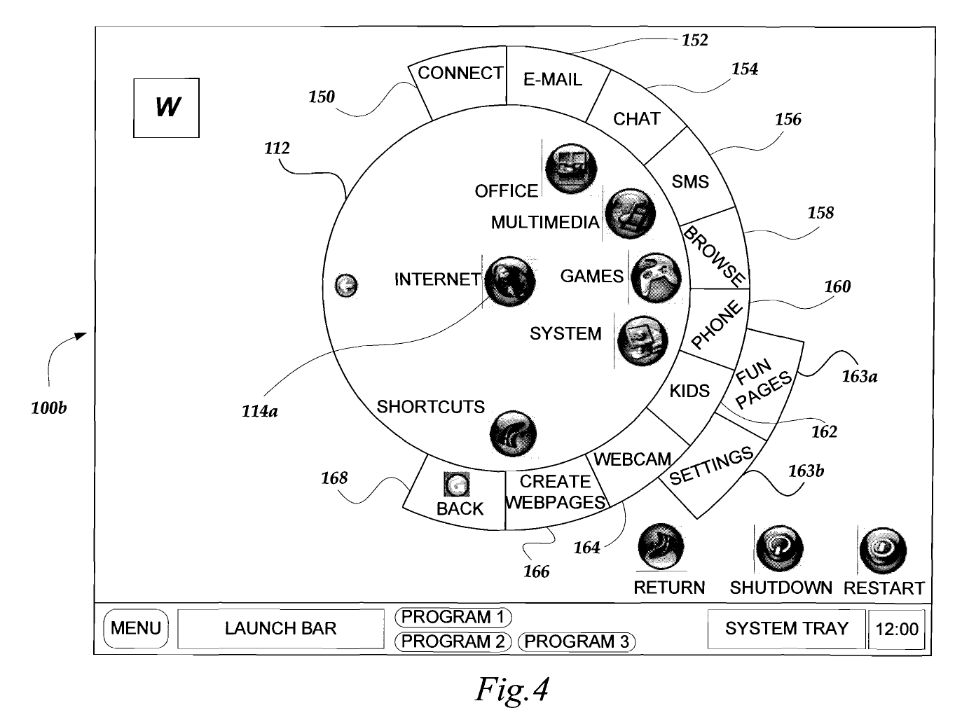

FIG. 4 is a screen print illustrating a desktop environment 100b with circularly fanned tabs 150-168 of software services and/or submenus that are associated with a selected service icon in the exemplary desktop environment of FIG. 3. For example, when a user moves a cursor over internet icon 114 shown in FIG. 3, the internet icon is moved to the center of menu background 112, as shown in FIG. 4 by internet icon 114a. The relocation of internet icon 114a can be instantaneous, performed with an animation, or accomplished with other audio/visual techniques. Detection of the cursor over the internet icon also causes circularly fanned tabs 150-168 to be displayed around the perimeter of menu background 112. The circularly fanned tabs can be displayed with animation, colors, lighting, and other visual effects. The user can then left click on one of the fanned tabs to initiate a corresponding service. If a fanned tab simply represents a group of services, moving the cursor over that fanned tab will initiate display of an outer level of tabs that represent a submenu of services. For instance, if the cursor is moved over a kids tab 162, outer level tabs 163a and 163b are displayed to provide access to another menu level and/or an executable service. A back tab 168 enables the user to remove a level of tabs or return focus to the service icons.

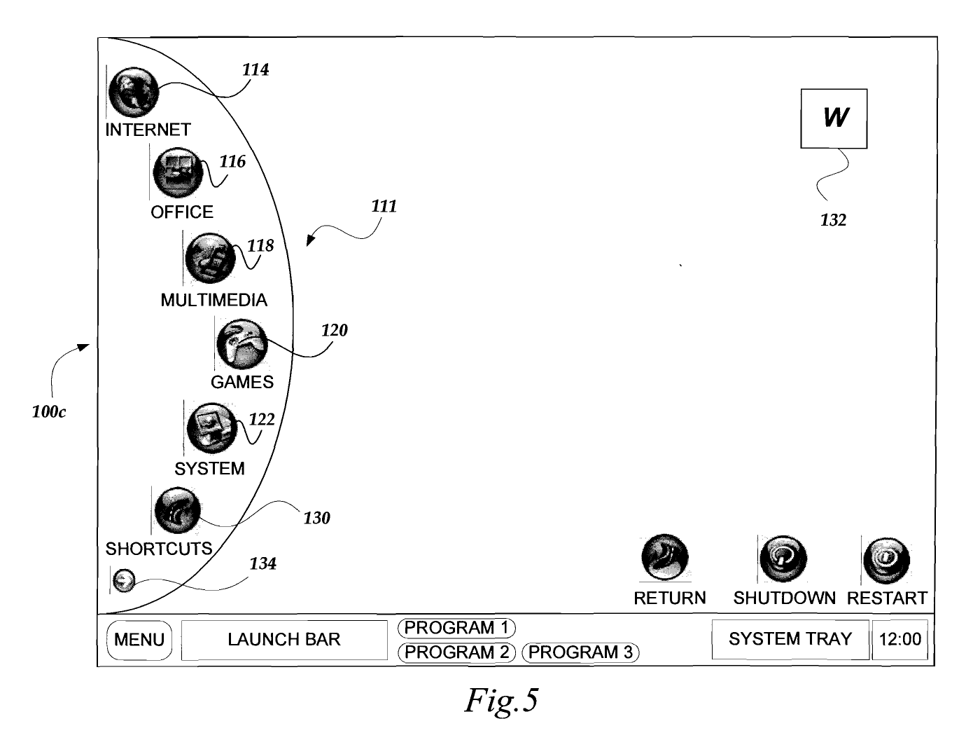

FIG. 5 is a screen print illustrating a desktop environment 100c that displays a side curved menu 111 resulting from a user activating menu location control icon 134 to move the menu to the left portion of the desktop environment. In this case, service icons 114-122 are arranged in a curve at the left along with display control icons 130 and 134. Shortcuts, such as shortcut 132, can be relocated as a result of moving the location of the menu.

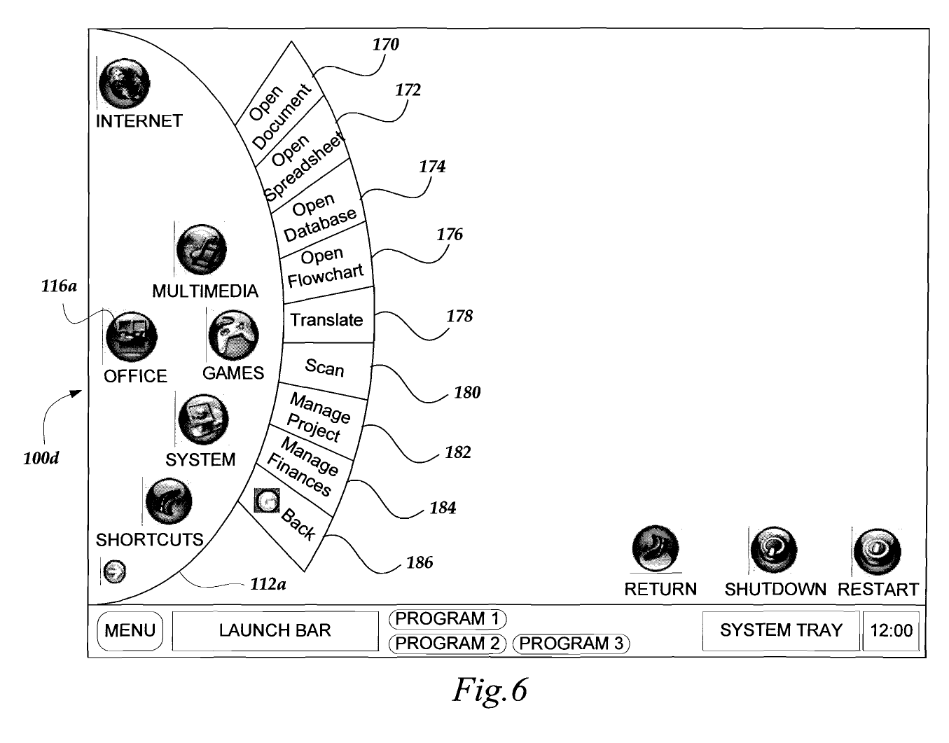

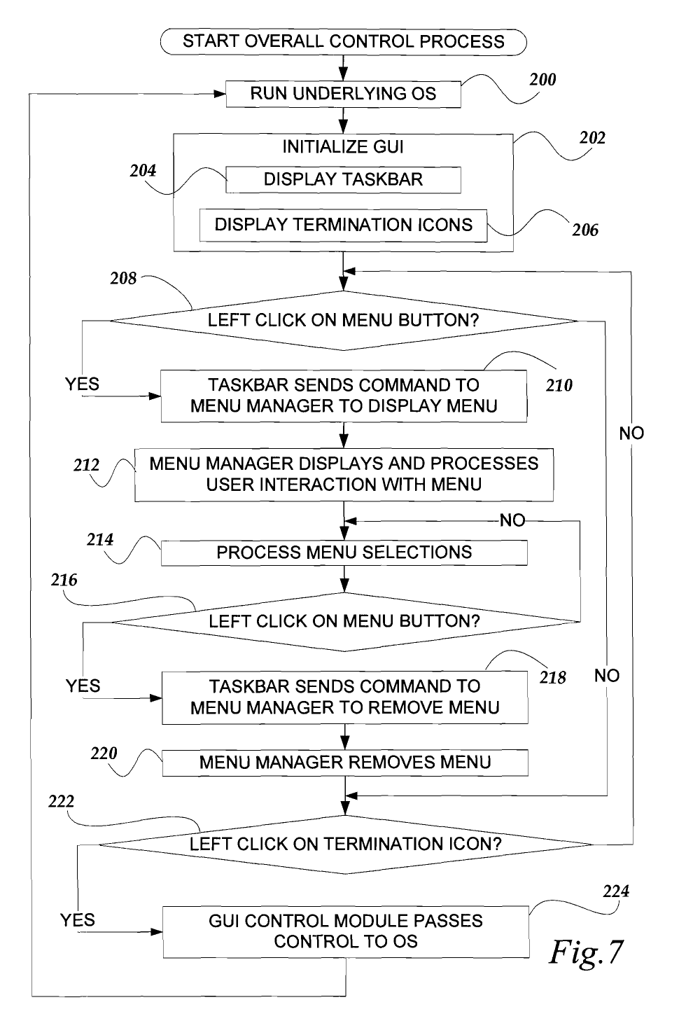

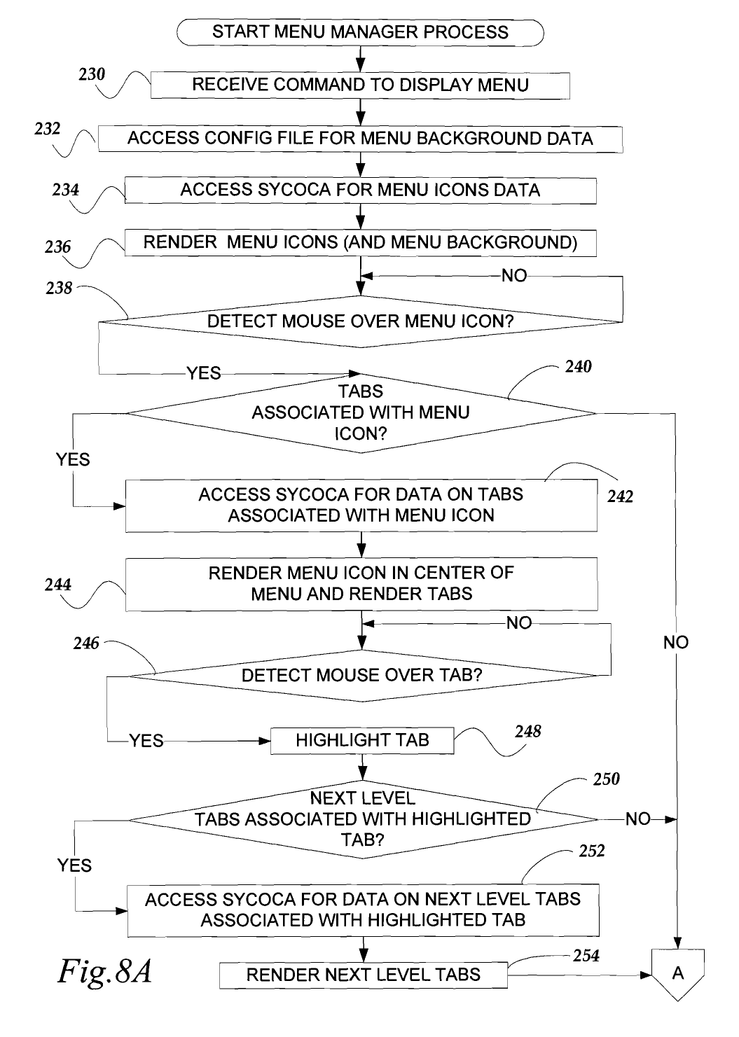

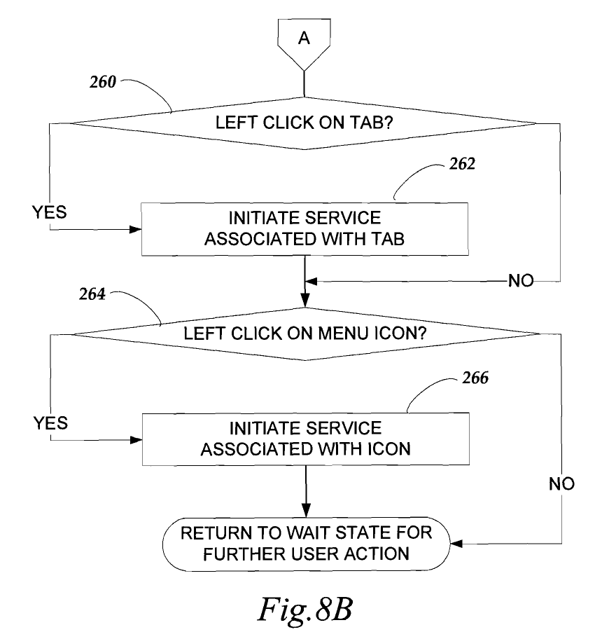

FIG. 6 is a screen print illustrating a desktop environment 100d that displays elliptically fanned tabs 170-186 of software services and/or submenus that are associated with a selected service icon in the exemplary desktop environment of FIG. 5. For example, when a user moves a cursor over office icon 116 shown in FIG. 5, the office icon is moved to the center of an elliptical menu background 112a, as shown in FIG. 6 by office icon 116a. Detection of the cursor over the office icon also causes elliptically fanned tabs 170-186 to be displayed around the perimeter of elliptical menu background 112a. The user can then left click on one of the fanned tabs to initiate a corresponding service. If a fanned tab simply represents a group of services, moving the cursor over that fanned tab will initiate display of an outer level of tabs that represent a submenu of services.

Process Descriptions

Now described are various processes performed by a computing device according to an exemplary embodiment of the invention. The processes and other operations of this exemplary embodiment can be performed in a plurality of sequences in addition to those described below.

FIG. 7 is a flow diagram illustrating overall logic controlling interaction with a menu according to an exemplary embodiment of the invention. At an operation 200 an underlying operating system is executed, such as Linux™, Microsoft Windows™, and the like. The operating system can be configured to allow manual or automatic initiation of the inventive GUI control module at an operation 202. Initiation includes displaying a taskbar at an operation 204, displaying termination icons at an operation 206, and/or performing other setup processes.

At a decision operation 208, the taskbar module determines whether the user has selected the menu button on the task bar. When the user selects the menu button, the taskbar module sends a command at an operation 210, instructing the menu manager to display the menu. At an operation 212, the menu manager renders the menu with icons, text, background, and/or other graphic characteristics. The menu manager also processes user interaction with the menu such as detecting a cursor over an icon and displaying a set of tabs. At an operation 214, the menu manager processes user selections such as mouse clicks on an icon or tab of the menu. Additional details concerning operations 212 and 214 are discussed with regard to FIG. 8.

The menu manager continues to process user interactions and selections unless the user selects the menu button on the taskbar while the menu is active. If the menu is not currently visible, selecting the menu button causes the GUI to redisplay the menu as described above. However, if the menu is currently displayed and has focus, then selecting the menu button will cause the GUI to remove the menu from display. Specifically, if the taskbar module detects a mouse click on the menu button at a decision operation 216, the taskbar module sends an instruction to the menu manager at an operation 218 to remove the menu from the display at an operation 220.

In one exemplary embodiment, the termination icons are displayed during initialization of the GUI, and remain available in the desktop environment. The termination icons may be displayed in the desktop area or within the menu background if the menu manager is controlling the termination icons. Alternatively, the termination icons may be displayed in the taskbar if the taskbar module is controlling the termination icons. In any case, at a decision operation 222, one of those modules or the GUI control module determines whether the return, shutdown, or restart icon was selected. If none of the termination icons were selected, the GUI control module simple waits for another action, such as selection of the menu button at decision operation 208. However, if one of the termination icons is selected, the control module informs the operating system of the selection and returns control to the operating system at an operation 224.

FIGS. 8A and 8B comprise a flow diagram illustrating logic of a menu management process according to an exemplary embodiment of the invention. At an operation 230, the menu manager receives a command from the taskbar module to display the menu. The menu manager accesses the configuration file at an operation 232 for screen coordinates and other graphical data of icons, an optional menu background, and other visual elements. The menu manager also accesses the sycoca at an operation 234 to determine which png files and/or text to be displayed as the service icons in the menu, the termination icons in the desktop environment, and any additional visual elements. (Note that the taskbar module may access the sycoca or an alternate source for data regarding the termination icons if they are to be displayed and controlled through the taskbar.) At an operation 236, the menu manager renders the service icons, the termination icons, and other visual elements.

At a decision operation 238, the menu manager receives an indication, or determines whether the cursor is hovering over a menu service icon (referred to herein as a hovered-over icon). The menu manager then checks the sycoca to determine, at a decision operation 240, whether that hovered-over icon is associated with a submenu of one or more tabs, or is associated with a single data processing service. If the menu service icon is associated with a data processing service, control passes to the logic of FIG. 8B for further processing as illustrated by a connector A. If the menu service icon is associated with a submenu, the menu manager accesses a directory file of the sycoca at an operation 242 to determine the png files, text, and/or other data defining the submenu tabs that are associated with the hovered-over icon. At an operation 244, the menu manager renders the hovered-over icon in the center of the menu and renders the submenu tabs. The rendering can be performed with animation, highlighting, sounds, and/or other effects. For example, the hovered-over icon can be gradually moved from its original position to the center of the menu. The submenu tabs can appear to fan out around the periphery of the menu background in a manner similar to fanning out a set of cards. The submenu tabs need not be visually tied to the menu background. Although the exemplary embodiments illustrated in FIGS. 3-6 show that the menu and submenu tabs are not limited to the areas near the taskbar, the tabs can utilize an even large portion of the desktop environment. For instance, larger tabs can be used for easier visibility by distributing the submenu tabs around the outer edge of the desktop environment.

A similar process is performed when the user moves the cursor over one of the submenu tabs. When the menu manager is notified, or detects at a decision operation 246, that the cursor is hovering over one of the submenu tabs, the menu manager changes the hovered-over tab to appear highlighted at an operation 248. The menu manager then checks the sycoca to determine, at a decision operation 250, whether that hovered-over tab is associated with a next level menu of one or more tabs, or is associated with a single data processing service. If the hovered-over tab is associated with a data processing service, control passes to the logic of FIG. 8B for further processing as illustrated by connector A. If the hovered-over tab is associated with a next level menu, the menu manager accesses a directory file of the sycoca at an operation 252 to determine the png files, text, and/or other data defining the next level tabs that are associated with the highlighted hovered-over tab. At an operation 254, the menu manager renders the next level tabs.

FIG. 8B illustrates exemplary logic for processing a user's selection of an icon or a tab that is associated with a data processing service. At a decision operation 260, the menu manager is notified, or detects that the user has selected a tab. The menu manager then checks a desktop file of the sycoca at an operation 262 to determine a data processing service to perform that is associated with the selected tab. The data processing service can be an application program, access to a system configuration service, access to a communication service, access to an individual data file, and/or other services. Similarly, at a decision operation 264, the menu manager is notified, or detects that the user has selected a menu service icon, a termination icon, the menu arrow icon, or other visual element that is associated with a service. The menu manager checks a desktop file of the sycoca at an operation 266 to determine a service to perform that is associated with the selected icon.

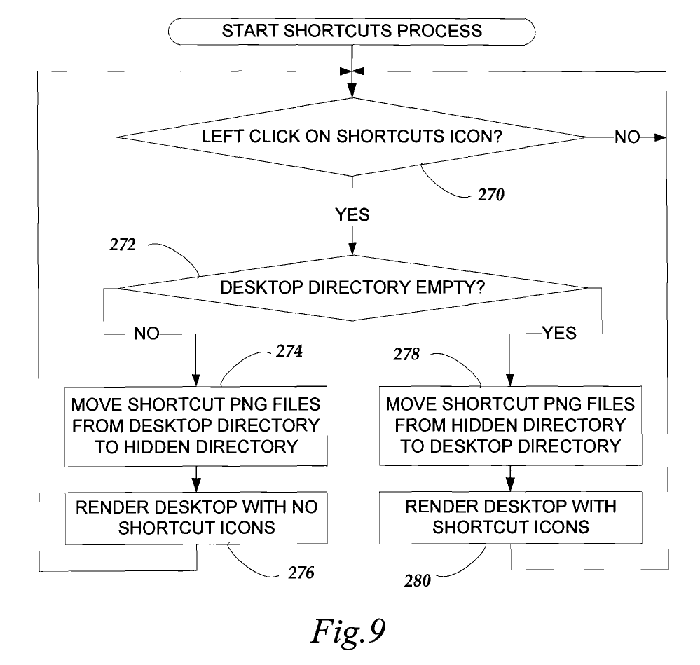

FIG. 9 is a flow diagram illustrating logic for toggling display of shortcuts in the desktop environment according to an exemplary embodiment of the invention. At a decision operation 270, the menu manager is notified or detects that the user has selected the shortcuts icon. The menu manager then determines, at a decision operation 272, whether a desktop directory is empty. An empty desktop directory indicates that no shortcuts are displayed in the desktop area, and the user wishes to display the shortcuts in the desktop area. Conversely, a non-empty desktop directory indicates that shortcuts are already displayed in the desktop area, and the user wishes to remove the shortcuts from the desktop area. Those skilled in the art will recognize that a lookup table or other technique can be used to determine whether shortcuts are currently displayed in the desktop environment.

In this exemplary embodiment, if the desktop directory is not empty, the menu manager moves shortcut png files from the desktop directory to a hidden directory at an operation 274. The menu manager then instructs the computing device to refresh the display at an operation 276, which causes the desktop environment to be displayed without any shortcut icons. In contrast, if the desktop directory is empty, the menu manager moves any stored shortcut png files from the hidden directory to the desktop directory at an operation 278. The menu manager then instructs the computing device to refresh the display at an operation 280, which causes the desktop environment to be displayed with shortcut icons.

Operating Environment

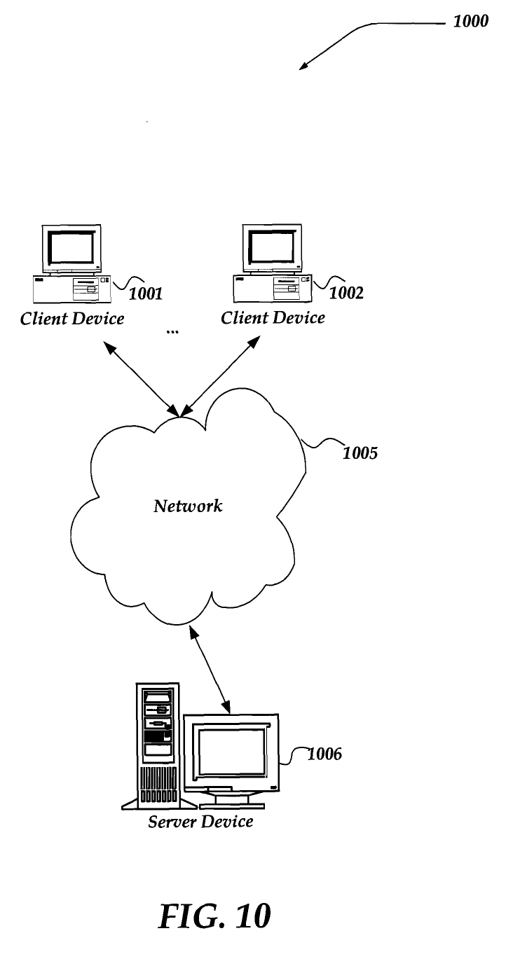

FIG. 10 shows components of an environment in which one or more embodiments of the invention may be practiced. Not all the components may be required to practice the invention, and variations in the arrangement and type of the components may be made without departing from the spirit or scope of the invention. As shown, system 1000 of FIG. 10 includes network 1005, server device 1006 and client devices 1001-1002.

One embodiment of client devices 1001-1002 is described in more detail in conjunction with FIG. 1. Generally, however, client devices 1001-1002 may include virtually any computing device capable of communicating over a network to send and receive information. The set of such devices may include devices that typically connect using a wired or wireless communications medium such as personal computers, multiprocessor systems, microprocessor-based or programmable consumer electronics, network PCs, or the like. In one embodiment, client devices 1001-1002 may be configured to provide a GUI to a user to enable access to a plurality of categories of services on client devices 1001-1002, enable transferring a file between client devices 1001-1002 and another device, or the like. Client devices 1001-1002 may use the processes described in FIGS. 7, 8A, 8B, 9, 11, and/or 12 to perform at least some of their operations.

Network 1005 is configured to couple server device 1006 and its components with other computing devices, including, client devices 1001-1002. Network 1005 is enabled to employ any form of computer readable media for communicating information from one electronic device to another. Also, network 1005 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 1005 includes any communication method by which information may travel between server device 1006, client devices 1001-1002, and other computing devices.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

One embodiment of server device 1006 is described in more detail in conjunction with FIG. 1. Briefly, however, server device 1006 may include any computing device capable of connecting to network 1005 to enable providing a GUI to a client device over a network, enabling transferring of files, remote editing of files, or the like. Server device 1006 may use the processes described in FIGS. 7, 8A, 8B, 9, 11, and/or 12 to perform at least some of its operations. Devices that may operate as server device 1006 include personal computers desktop computers, multiprocessor systems, microprocessor-based or programmable consumer electronics, network PCs, servers, and the like. Although FIG. 10 illustrates server device 1006 as a single computing device, the invention is not so limited. For example, one or more functions of server device 1006 may be distributed across one or more distinct computing devices.

Alternate Processes

Now described are various alternate processes performed by a computing device according to an exemplary embodiment of the invention. The processes and other operations of this exemplary embodiment can be performed in a plurality of sequences in addition to those described below.

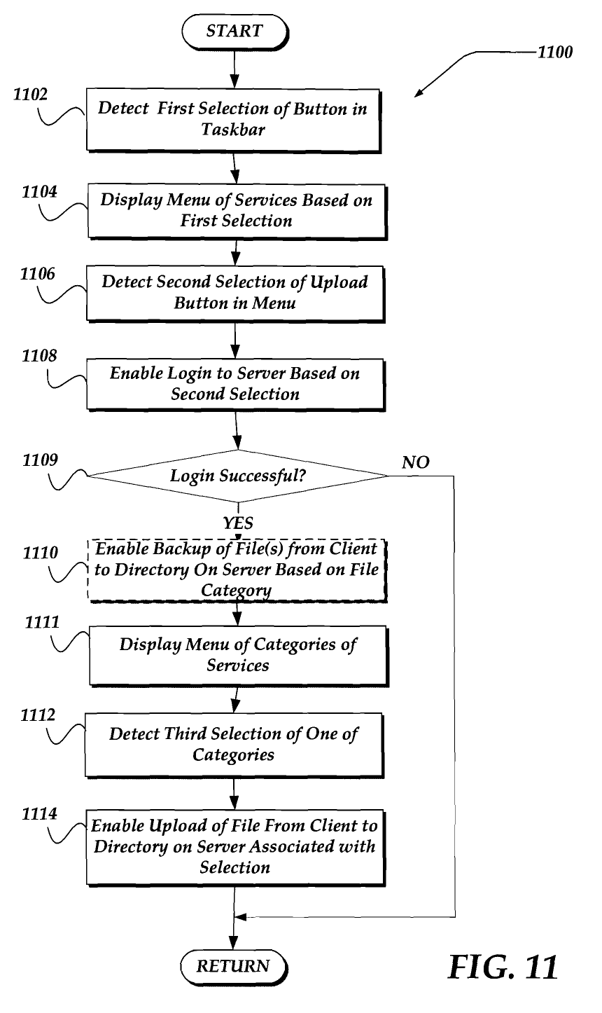

FIG. 11 is a flow diagram illustrating overall logic controlling interaction with a menu according to an exemplary embodiment of the invention. Process 1100 of FIG. 11 may be performed by server device 1006 and/or client devices 1001-1002 of FIG. 10.

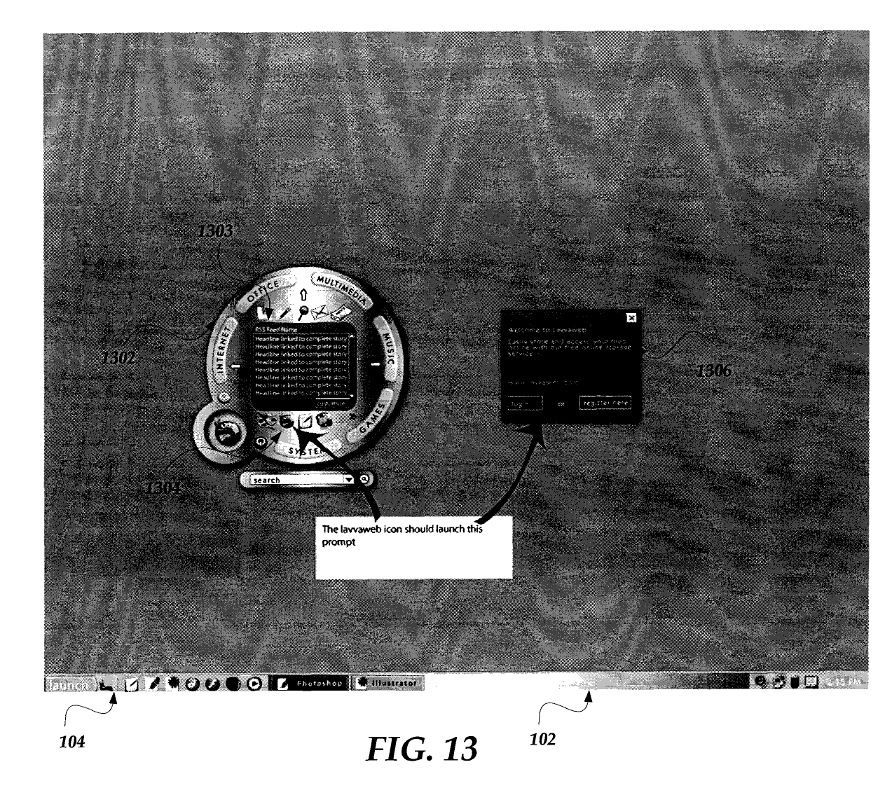

Process 1100 begins at block 1102, where a first selection of a button in a taskbar is detected. The button may be any visual representation, icon, or the like within the taskbar. The button may be, for example, menu activation button 104 of FIG. 13. The taskbar may be, for example, taskbar 102 of FIG. 13. Processing next continues to block 1104.

At block 1104, a menu of services is displayed based on the first selection. Referring briefly to FIG. 13, in one embodiment, centrally circular menu 1302 is activated and displayed when a user makes a first selection of menu activation button 104 within taskbar 102. As shown, centrally circular menu 1302 comprises a number of menu elements substantially similar to centrally circular menu 10, described in conjunction with FIG. 3. Centrally circular menu 1302 may include a plurality of buttons for enabling access to a plurality of categories of services of a computer desktop environment (e.g., “INTERNET”, “OFFICE”, “MULTIMEDIA”, “MUSIC”, “GAMES”). Centrally circular menu 1302 may also display information menu 1303. In one embodiment, information menu 1303 does not overlap other buttons or components within centrally circular menu 1302. Additionally, centrally circular menu 1302 may also include upload button 1304. Referring back to process 1100, processing then continues to block 1106.

At block 1106, a second selection of an upload button is detected. Referring again to FIG. 13, a user may make the second selection of upload button 1304, for example, by clicking on upload button 1304. Processing then continues to block 1108.

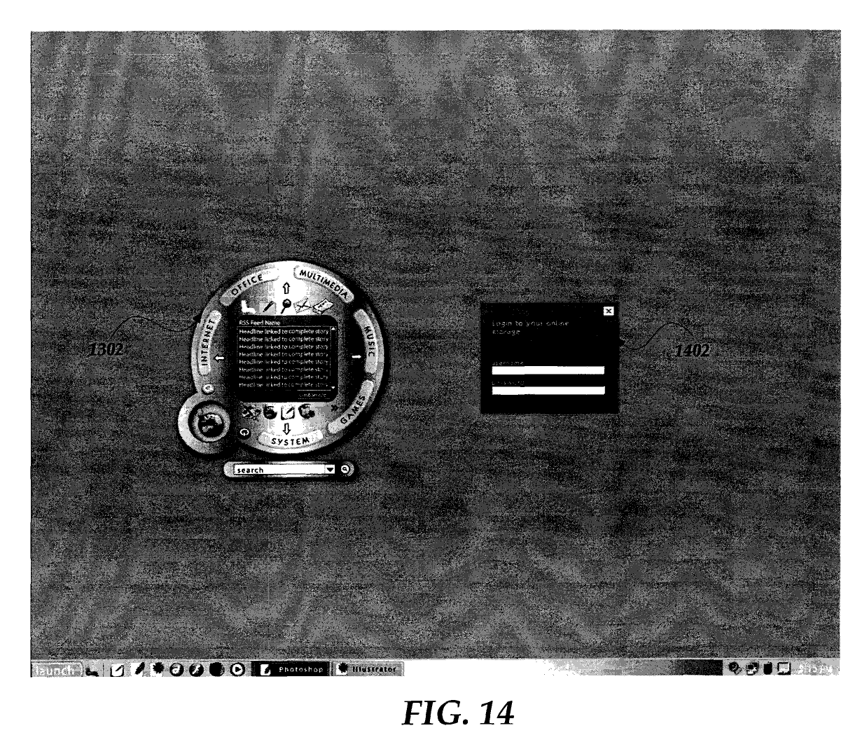

At block 1108, a login to a server is enabled based on the second selection. For example, login menu 1306 of FIG. 13 may be displayed, near the centrally circular menu 1302. The user may be click on a “login” button, or the like. If the user has not already registered as an account on the server, the user may register at block 1108, using for example, login menu 1306. If the user selects the “login” button, menu 1402 of FIG. 14 may be displayed. Menu 1402 shows a user name and password entry to enable the user to enter the appropriate information to authenticate and/or authorize the user and/or the program enabling the login to access the server, or the like. Other mechanisms for login may also alternatively be used, including automatic login, command line login, or the like. Processing then continues to decision block 1109.

At decision block 1109, it is determined whether the login was successful. If the user entered appropriate information and/or the user was properly authenticated and/or authorized, then processing continues to block 1110. Otherwise, processing returns to a calling process for other processing.

At block 1110, a plurality of files on the client may be uploaded to the server, thereby backing up the plurality of files. The plurality of files may be specified as one or more directories, on for example a hard disk drive, such as hard disk drive 28 of FIG. 2, a USB drive, or any other internal or external storage on the client. A category of a plurality of categories of services is determined for each of the plurality of files based on the type of the file(s) (e.g., based on their extension, such as “.mpg”, name such as “music.mpg”, content, or the like). A destination directory is determined based on the determined category. The plurality of files may then be automatically (e.g., without user intervention) uploaded and saved to the destination directory on the server associated with the appropriate category for the particular file.

In one embodiment, the backup-ed and uploaded files may be stored as a new copy of the files and may overwrite the older copies. In another embodiment, a delta or change in the files may be stored. In yet another embodiment, a version history may be stored, or any other form of backup versioning and rollback mechanism may be enabled.

In one embodiment, block 1110 may be optional and may not be performed. In another embodiment, block 1110 may be performed automatically on a scheduled basis, or the like. In this embodiment, block 1102, 1104, 1106, 1108 may not be performed. Instead, the user may automatically be logged in based on saved account information, and the files may automatically be sorted into a particular category and uploaded to a directory associated with the particular category on the server.

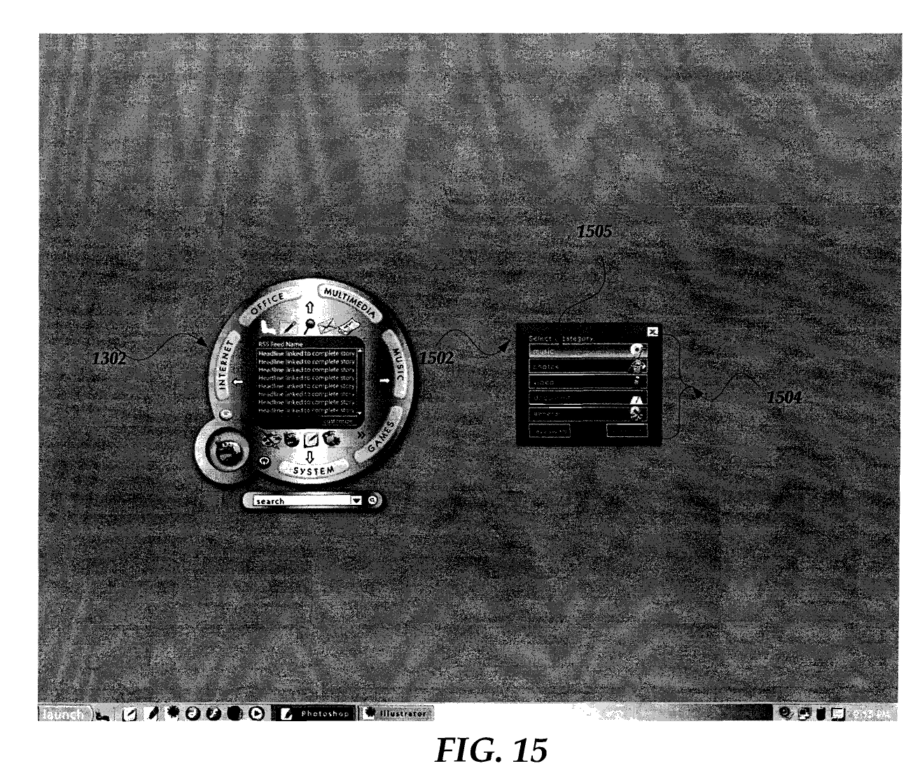

At block 1111, a menu of categories of services is displayed. For example, menu 1504 of FIG. 15 may be displayed to user on the desktop, near the centrally circular menu 1302. As shown, menu 1504 includes buttons for a plurality of categories of services (e.g., “MUSIC”, “PHOTOS”, “VIDEO”, “DOCUMENTS”, “GENERAL”). In one embodiment, the plurality of categories may correspond, but need not correspond, to centrally circular menu 1302's plurality of buttons for enabling access to a plurality of categories of services. Although shown as a rectangular menu, in another embodiment, the plurality of categories may be shown in a circular fashion as in menu 1302.

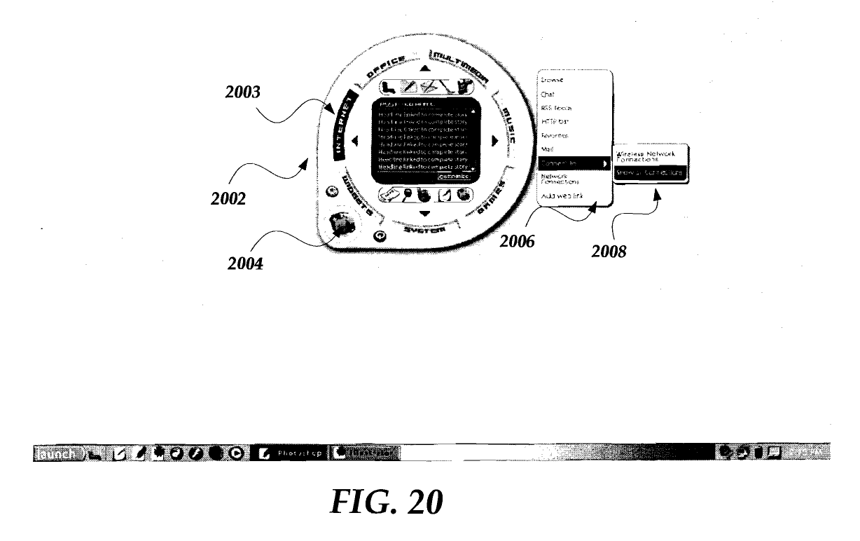

In one embodiment, a hierarchical menu of sub-categories may be displayed based on a selection of one of the plurality of categories, wherein an item in the hierarchical menu is configured to enable activation of an application associated with a selected sub-category, and wherein the hierarchical menu is disconnected and adjacent to the menu. FIGS. 20-24 shows examples of such hierarchical menus of sub-categories. Processing then continues to block 1112.

At block 1112, a third selection of one of the categories is detected. For example, a user may click on, or otherwise select, button 1505 of FIG. 15. The third selection may indicate that the selected category (e.g., “music”) is to be used to perform other operations. Processing then continues to block 1114.

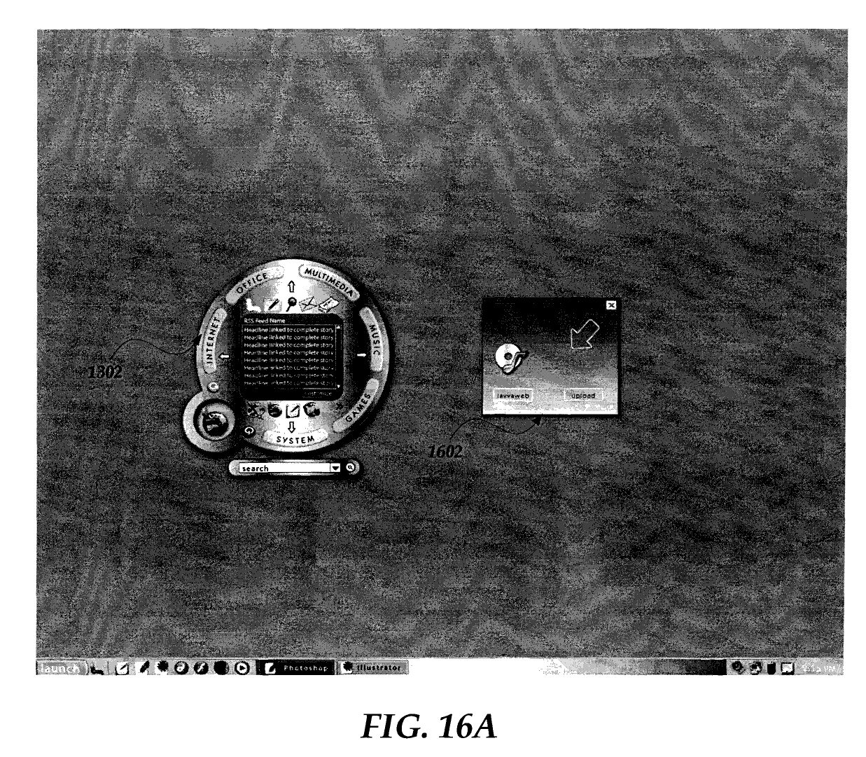

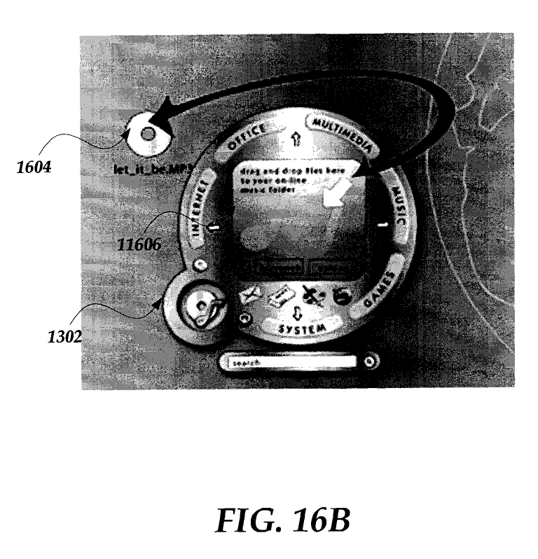

At block 1114, an upload of a file from the client to a directory on the server associated with the selection is enabled. For example, menu 1602 of FIG. 16A may enable the upload of a file from the client to a directory on the server associated with, for example, the selection of the category “music.” As shown, menu 1602 may be displayed substantially near centrally circular menu 1302. However, in an alternate embodiment, menu 1602 may be displayed on top of and/or within centrally circular menu 1302, for example, as shown in FIG. 16B. In one embodiment, menu 1602 may replace information menu 1303.

An upload may be enabled with menu 1602, or any other upload mechanism. For example, a directory browser of the local file system of the client may enable selection of the file. The file may then be uploaded to the server. Alternatively, the user may drag the file from a local directory, local desktop, or other user interface display, and drop the file onto menu 1602.

In any case, the file may then be transferred to the server over a network, via any protocol, including FTP, HTTP, XML, NT Directory Service (NTDS), Lightweight Directory Access Protocol (LDAP), another directory service based on for example, the X.500 distributed directory services model, or the like. The file may then be copied and/or moved to the directory or location on the server associated with the selection. For example, file 1604 of FIG. 16B may be moved, copied, or otherwise transferred to a “music” directory on the server. Processing then returns to a calling process for further processing.

While process 1100 describes the use of centrally circular menu 1302, any other type of menu may be used without departing from the scope of the invention. For example, a side curved menu substantially similar to side curved menu 111, and/or including information menu 1303, upload button 1304, or the like, may be used.

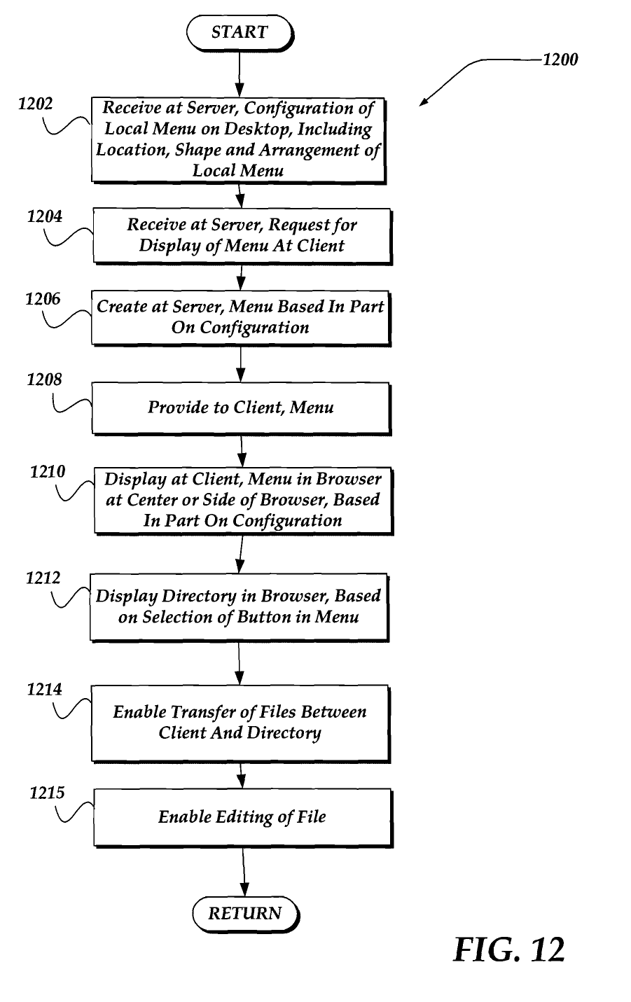

FIG. 12 is a flow diagram illustrating overall logic for providing a user interface over a network. Process 1200 of FIG. 12 may be performed by server device 1006 and/or client devices 1001-1002 of FIG. 10.

Process 1200 begins at block 1202, where a configuration of a local menu on a desktop is received at a server, wherein the configuration includes a location, shape, and/or arrangement of the local menu. The configuration may be received over a network. In one embodiment, the local menu is located in a local display area that is visually independent of a desktop taskbar displayed at the desktop. For example, the local menu may be centrally circular menu 110, centrally circular menu 1302, side curved menu 111 or the like. In one embodiment, the local menu may be located in a local display area that is visually independent of the desktop taskbar, or the like.

In one embodiment, the configuration may include the location of the local menu (e.g., in the central area of the desktop display, on the side of the desktop display). The configuration may include the shape of the menu (e.g., circular, oblong, curved, rectangular). The configuration may include an arrangement of the buttons, including the plurality of buttons associated with the services, upload button 1304, or other layout information about the menu. The configuration may be sent over any protocol, including HTTP, FTP, XML, or the like. Processing then continues to block 1204.

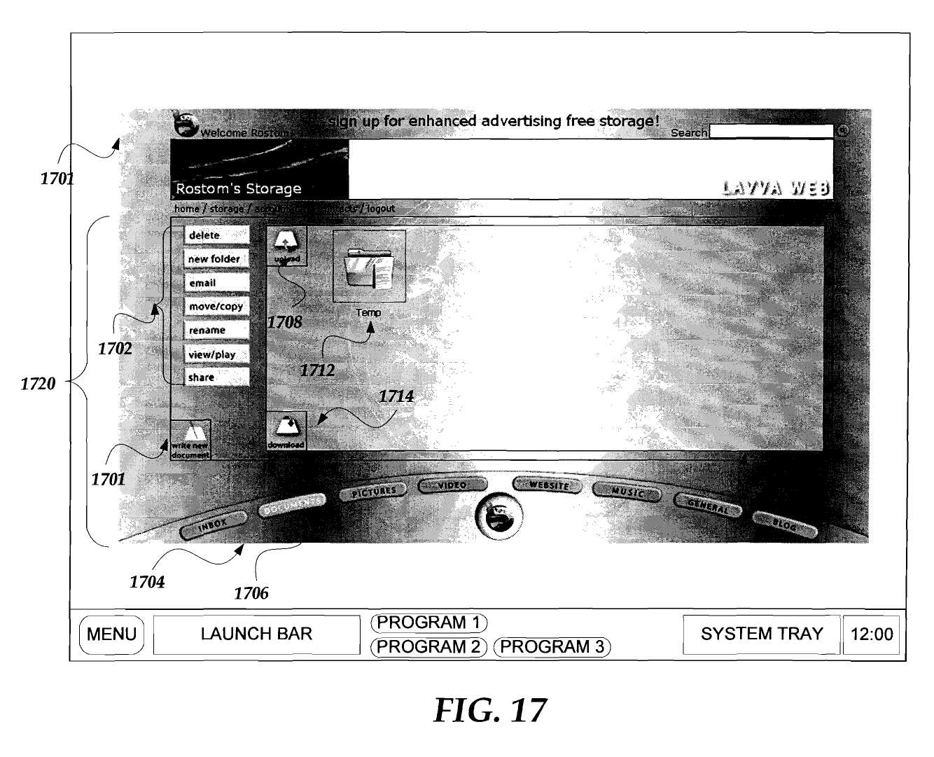

At block 1204, a request for a display of a menu at the client is received at the server. The request may be for a remotely displayed menu. The remotely displayed menu may be configured to be displayed in a web browser, or the like. For example, the request may be for the display of menu 1704 of FIG. 17 to be displayed in browser 1701 on the client.

The request may be received over the network. The request may received over any protocol, including HTTP, FTP, XML, or the like. The request may be sent in response to accessing a website, via a browser, by logging onto the website, clicking on a button in a taskbar, or the like. Processing then continues to block 1206.

At block 1206, the menu is created at a server based in part on the received configuration. In one embodiment, a data structure, or other information may be assembled, configured, or the like, on the server. An object may include information about the menu, and may be used on the server. The object may be a JAVA object, a persistent object, a shared object or the like. The object may be sent to the client and stored on the client in a cookie at the browser, or the like.

In one embodiment, the data structure, object, cookie, or other information associated with the menu may be based on the received configuration. For example, the location, shape, and/or arrangement may be based on the received configuration. In one embodiment, the menu is configured to be displayed in a visually similar manner as the local menu. As shown in FIG. 17, side curved menu 1704 may include a shape, size, location, and/or an arrangement of buttons, or the like, similar to a local menu displayed on a local desktop and/or in a local menu (e.g., centrally circular menu 110, centrally circular menu 1302, side curved menu 111). Processing then continues to block 1208.

At block 1208, the menu is provided to the client. The menu may be provided to the client over the network and/or over a variety of mechanisms, and/or protocols, including HTTP, FTP, XML, or the like. For example, as shown in FIG. 17, the menu may be provided through a JAVA applet executing within browser 1702. The JAVA applet may display browser desktop 1720 which may include a variety of icons, directories, or other information. Side curved menu 1704 may be displayed at different locations within browser desktop 1720 based on the received configuration. A visual panel, pane, or the like, may be allocated, rendered, or the like in the applet. The panel, pane, or the like may include the visual components associated with side curved menu 1704. Widgets, or other graphical user interface components may also be used to display side curved menu 1704. In one embodiment, side curved menu 1704 may be movable. Menu 1704 may be movable to a central location, or any other side location of browser desktop 1720. The user may drag side curved menu 1704 by clicking on side curved menu 1704 and dropping the menu to a central or side location, or the like. The menu may then snap onto the particular location.

In one embodiment, moving or otherwise changing the configuration of side curved menu 1704 may enable sending a configuration of side curved menu 1704 to the client, or another client, associated with the configuration received at block 1702. The configuration of side curved menu 1704 may in turn be used to modify the look and feel of the menu on the local desktop to substantially match the location, size, color, shape, or arrangement of side curved menu 1704.

Although described as an JAVA applet in a browser, any other mechanism for displaying a remote GUI may be used, including using a proprietary GUI application, using Asynchronous JavaScript and XML (AJAX), JavaScript Object Notation (JSON), Dynamic HTML (DHTML), ActiveX components, or the like in a browser, or the like. Referring back to process 1200, processing continues to block 1210.

At block 1210, the menu is displayed in a browser at the client, at the center or side of the browser, based in part on the received configuration. As described above, side curved menu 1704 may be displayed in browser 1701 of FIG. 17. Side curved menu 1704 may be displayed at a different location, with a different shape, arrangement, size, or the like, within browser desktop 1720, based on the received configuration. Processing then continues to block 1212.

At block 1212, a visual representation of a directory is displayed in the browser based on of a selection of a button in the menu. Referring to FIG. 17, browser desktop 1720 may include a directory browser 1701 which may include a plurality of buttons 1702 for manipulating files/directories (e.g., “delete”, “new folder,” “email”, etc). In one embodiment, directory browser 1701 may show one directory at a time. Directory browser 1701 may show a directory associated with a button from a plurality of buttons for enabling access to a plurality of categories of services included in side curved menu 1704. For example, button 1706 for “documents” may be selected. Button 1706 may be user selected, a default selected button, a highlighted button, or the like. Correspondingly, directory 1715 may be associated with the directory “documents” stored or located on the server. Folders and/or files, such as folder 1712 may be included in directory 1715. Upload button 1708 and download button 1714 may also be displayed to enable transferring files to the directory on the server. Referring back to process 1200, processing then continues to block 1214.

At block 1214, a transfer of a file between the client and the directory on the server is enabled. The file may be transferred to the directory on the server over the network, via any protocol, including FTP, HTTP, XML, NT Directory Service (NTDS), Lightweight Directory Access Protocol (LDAP), another directory service based on for example, the X.500 distributed directory services model, or the like. The file may be copied and/or moved to the directory. The transfer may be enabled for example, by clicking button 1708 and/or 1714. The transfer may also be enabled by selecting the file from the local directory or by dragging-and-dropping a file onto a visual representation of the directory in the browser, or the like.

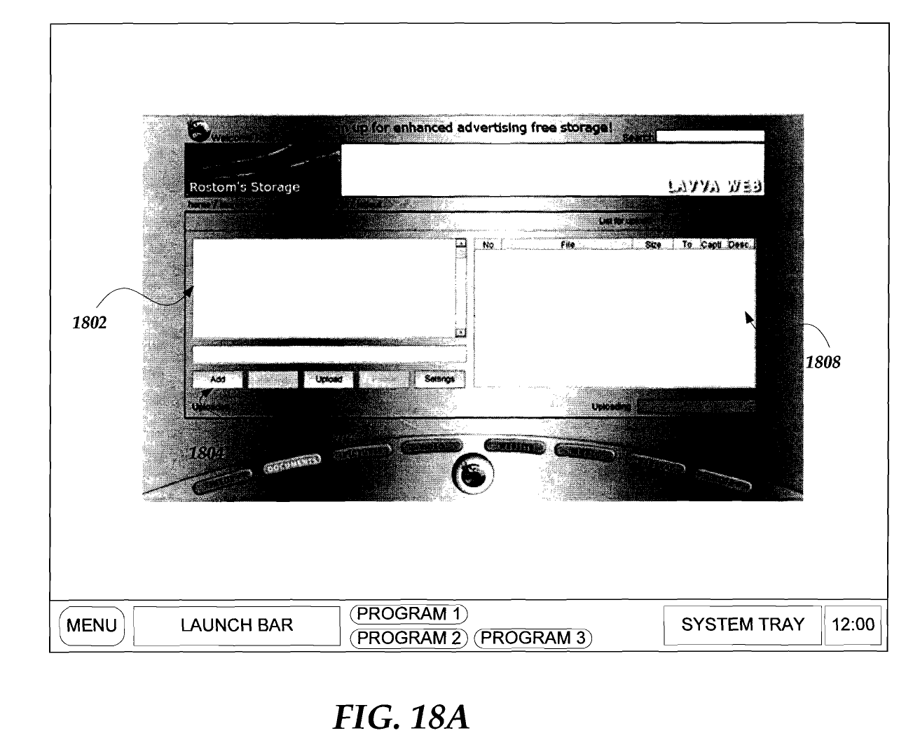

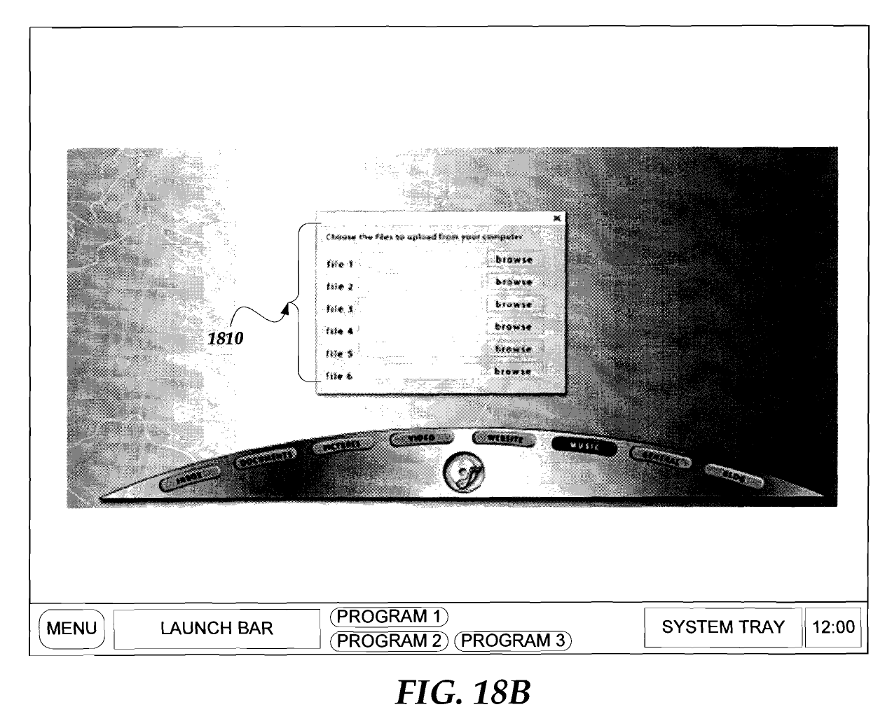

Referring to FIG. 18A, directory browser 1802 may show a local directory (e.g., a directory that enables access to files on the client). A user may select a file on the local directory on the client, and may drag-and-drop the file into upload list 1808. Alternately, the user may click on the “add” button, browse the directory in directory browser 1802 and select a file to be added to upload list 1808. The user may begin the upload process by clicking the “upload” button, or a file may be uploaded as soon as the file is placed in upload list 1808. Referring to FIG. 18B, in an alternate embodiment, a multi-upload list 1810 may be displayed, with a plurality of upload entries (e.g., “file 1”, “file 2”, etc). Each upload entry may enable browsing the local directory on the client, selecting a file to upload, dragging-and-dropping a file from the local directory onto the upload entry for upload, or the like. In any case, the file is uploaded to the directory on the server. Although block 1214 is described as enabling uploading of a file, a plurality of files may be uploaded, as shown in FIGS. 18A and 18B, without departing from the scope of the present invention.

In one embodiment, the directory on the server (e.g. directory 1802) is associated with the selected directory from block 1212. However, in an alternate embodiment, the files may be uploaded to a different directory, based on for example, the type of the file to be uploaded. For example, a file with an extension (e.g., “.mpg”) or otherwise associated with a particular file type (e.g., “music”) may be automatically uploaded to a folder corresponding to a directory of the appropriate type (e.g., a “music” directory).

Although not shown, browser 1701 of FIG. 17 may be displayed in response to the upload. The uploaded file may be displayed within directory 1715, for example. In any case, processing then continues to block 1215

At block 1215, a file (e.g., the uploaded file from block 1214) may be enabled to be edited. The file may be edited with an application (e.g., editor) associated with one of the plurality of categories of services associated with a menu such as menu 1704 of FIG. 7. In one embodiment, the user may launch the appropriate editor in the browser, using one of the buttons in menu 1704 associated with one of the plurality of categories. In another embodiment, the editor may be selected and launched based on a type of the selected and/or uploaded file.

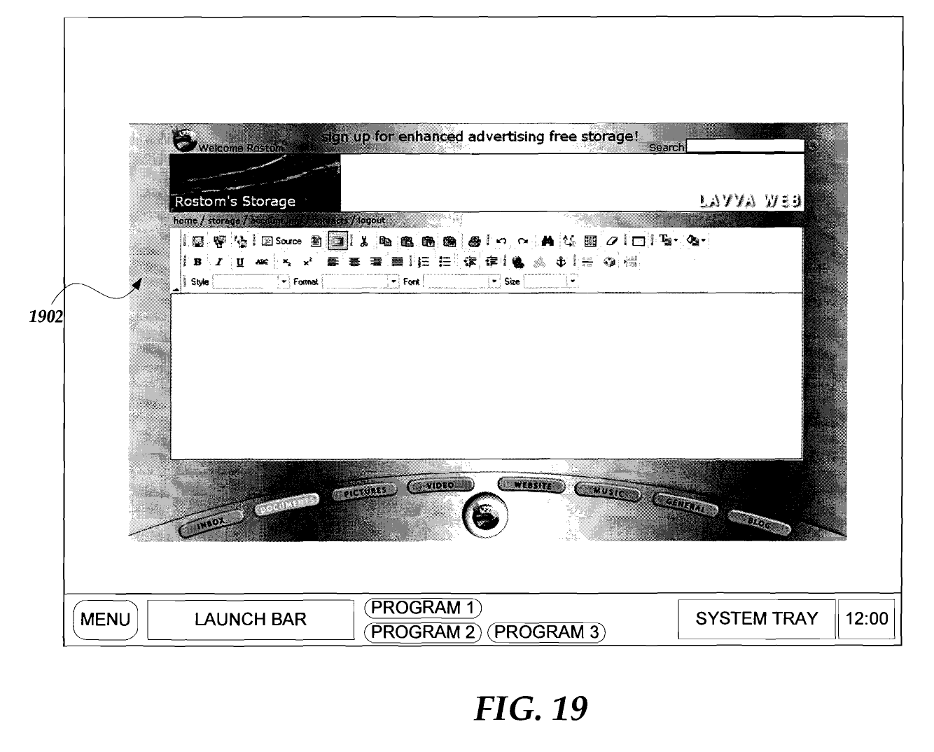

Referring to FIG. 19, embedded editor 1902 may enable editing of the file. Embedded editor 1902 may be a JAVA applet, ActiveX object, DHTML application, or the like. As shown, embedded editor 1902 may be a text editor, but any other editor, including a graphics editor, spreadsheet editor or the like may be used based on the type of the file (e.g., “.txt”, “.doc”, “.xls”, “,gif”, text document, html document, excel document, database document, etc). Embedded editor 1902 may enable the user to edit the file remotely and/or to save the file to the directory at the server, such as the directory associated with the (selected) plurality of categories of services. Processing then returns to a calling process for further processing.

In an alternate embodiment, the process of transferring, moving, copying, or uploading of files as described above in conjunction with FIGS. 11 and 12 also applies to directories or any other information. Thus, complete directories, compressed directories, file images or the like, may also be transferred as described above.

Alternate Screen Displays

FIGS. 20-24 show examples of alternate embodiments of menu configurations. The menus of FIGS. 20-24 may be displayed at block 1111 of FIG. 11. FIG. 20 shows centrally circular menu 2002 in a desktop environment. Substantially similar to centrally circular menu 110, centrally circular menu 2002 is activated and displayed when a user left clicks on a menu activation button within a taskbar. However, unlike the process controlling centrally circular menu 110, in FIG. 20, a selection of icon 2003 which represents a category of categories of services enables another icon 2004 associated with the category (e.g., “Internet”) to appear in a side area adjacent to and connected to centrally circular menu 110. Moreover, selection of icon 2003 enables menu 2006 to be displayed. Menu 2006 provides a sub-categorization of the category. As shown, menu 2006 may be a rectangular menu disconnected from and adjacent to centrally circular menu 2002, but may be any other shape and/or may be connected to centrally circular menu 2002. Menu 2006 may also enable activation of a further menu 2008 for other sub-categorizations. Thus, the user interface shown in FIG. 20, and the process for controlling the user interface enables hierarchical selection of sub-categories of one of a plurality of categories of services. A final selection of an item in a menu such as menu 2006 or menu 2008 may enable activation of a program associated with one of the (sub) category of services.

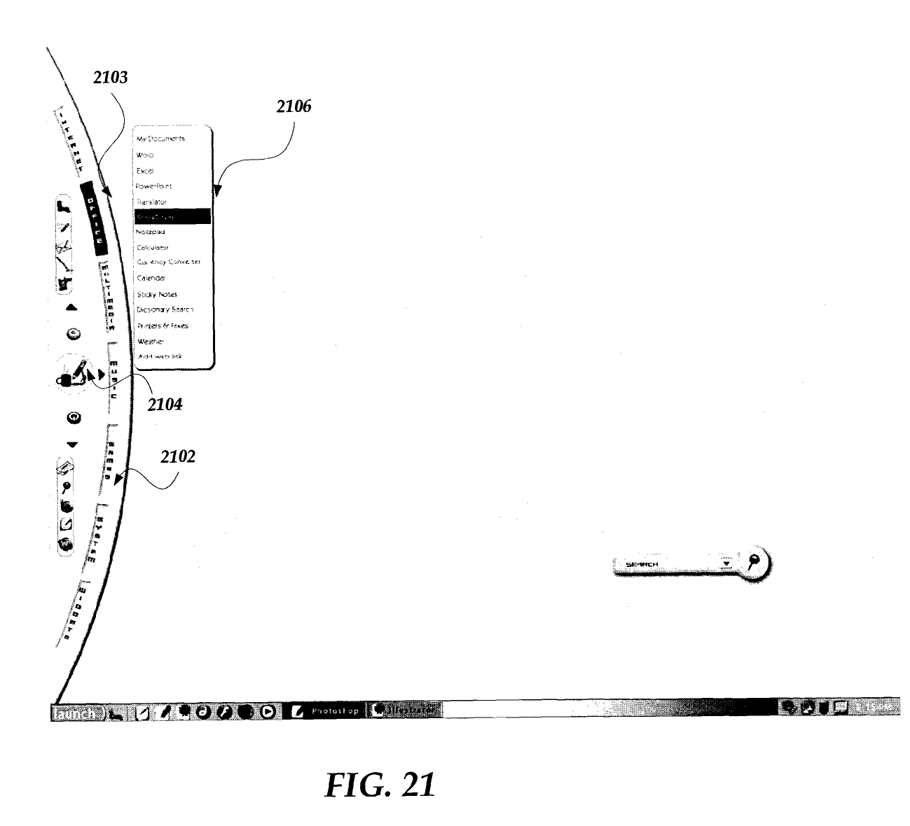

FIG. 21 shows side curved menu 2102. Side curved menu 2102 operates substantially similar to side curved menu 111 and/or centrally circular menu 2002. Selection of icon 2103 enables menu 2106 to be displayed. Unlike icon 2004 of centrally circular menu 2002, icon 2104 associated with the active category is displayed within the side curved menu 2102.

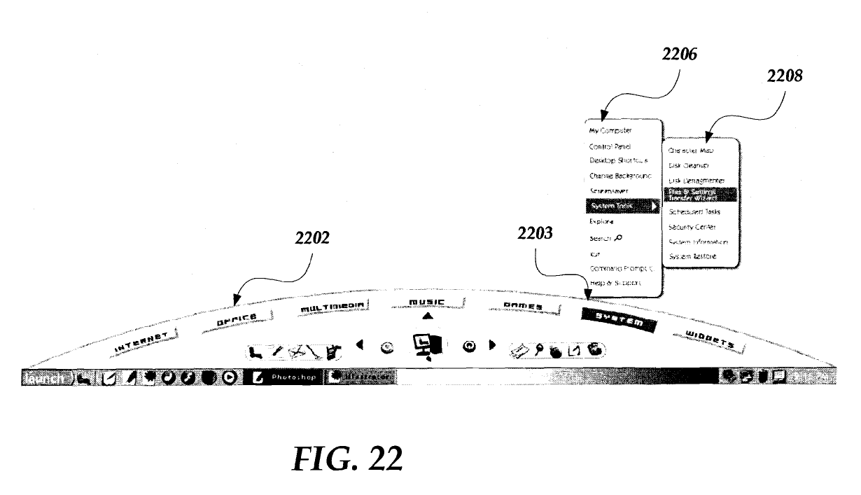

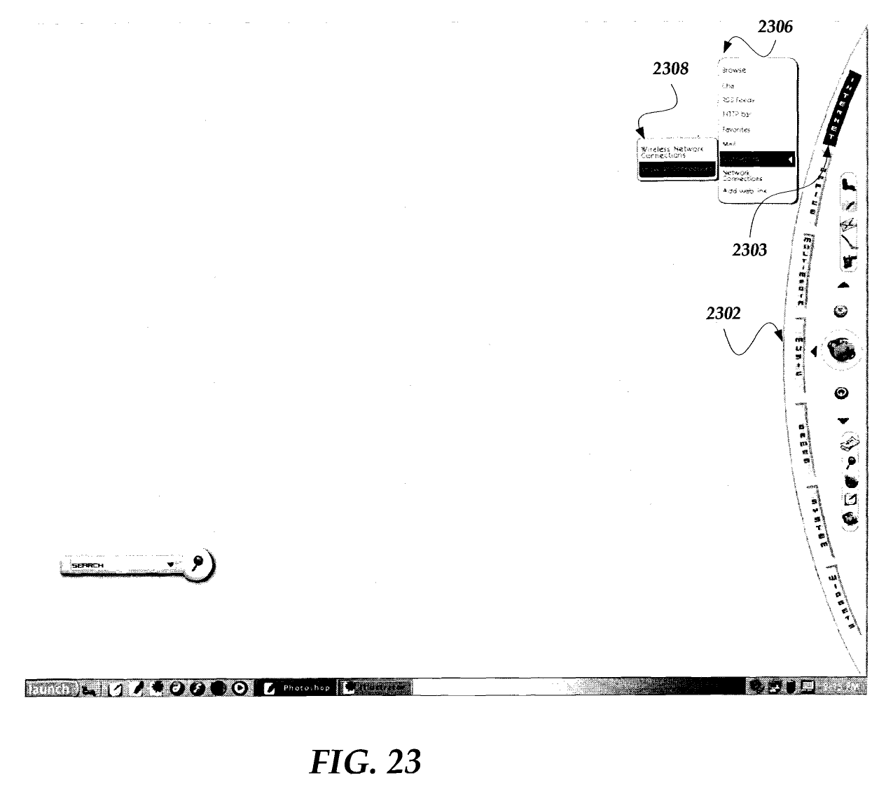

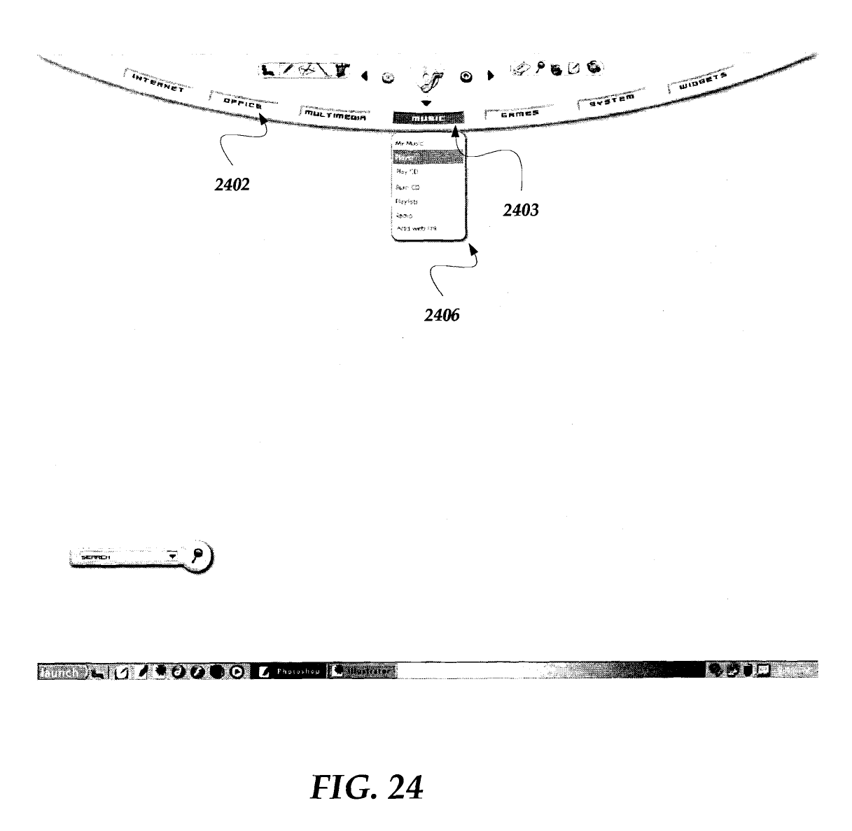

FIG. 22 shows bottom curved menu 2202. Bottom curved menu 2202 operates substantially similar to side curved menu 111 and/or centrally circular menu 2002. Selection of icon 2203 enables menu 2206 and/or menu 2208 to be displayed. FIGS. 23-24 also show similar configurations. For example, FIGS. 23-24 show similar side curved menus 2302 and 2402, icons 2303 and 2403, and menus 2306, 2308, and 2406. As discussed above, the curved menu location, service menu characteristics, background pattern, desktop icons, system tray icons, and/or other visual and function aspects can be communicated to a server to configure the network interface environment with the same visual and functional aspects. For example, the characteristics of FIG. 22 can be communicated to a server for setting the same characteristics in the server-based interface, such as curved menu and/or other aspects show in FIGS. 17, 18A, 18B, and 19. In this way, a user's customized interface can be consistent whether interacting with the user's own client device or interacting with the server through a browser on any other device.

The above specification, examples, and data provide a complete description of the manufacture and use of the composition of the invention. For example, the graphical user interface described above can be used for application program menus, so that the menu is independent of a rectangular menu toolbar. Since many embodiments of the invention can be made without departing from the spirit and scope of the invention, the invention resides in the claims hereinafter appended.

What is claimed as new and desired to be protected by Letters Patent of the United States is:

1. A method for providing a graphical user interface (GUI) over a network, comprising:
detecting a first selection of a graphical button displayed within a taskbar, wherein the graphical button enables a user to access a plurality of services of a computer desktop environment through a menu of services;
displaying the menu of the services in a display area that is visually independent of the taskbar in response to the first selection of the graphical button displayed within the taskbar;
detecting a second selection of a upload button displayed within the menu;
enabling a login to a server device based on the second selection;
displaying a menu of a plurality of categories of services, wherein each of the plurality associated with a different directory on the server, if the login is successful;
detecting a third selection of one of the plurality of categories; and
enabling an upload of a file from a client associated with the menu to the directory on the server associated with the third selection.

2. The method of claim 1, further comprising:
displaying a hierarchical menu of sub-categories based on a selection of one of the plurality of categories, wherein an item in the menu is configured to enable activation of an application associated with a selected sub-category, and wherein the hierarchical menu is disconnected and adjacent to the menu.

3. The method of claim 1, further comprising:
enabling an automatic backup of a plurality of a file on the client to a directory on the server associated with a type of the file, wherein enabling further comprises:
determining a category from a plurality of categories of services based on the type of the file;
determining the directory based on the determined category; and
saving the file into the directory on the server.

4. A method for providing a graphical user interface (GUI) over a network, comprising:
receiving at the server, a configuration of an local menu in a local display area that is visually independent of a desktop taskbar displayed at a desktop, wherein the configuration includes a location of the local menu, a shape of the local menu, and an arrangement of the buttons in the local menu;
receiving at a server, a request for a display of a menu at a client;
providing to the client over the network, the menu; and
displaying at the client, the menu in the browser at the client, in a display area that is located at central portion of the browser or a side portion of the browser based in part on the received configuration, wherein the menu includes buttons for a plurality of categories of services.

5. The method of claim 4, wherein the configuration further includes at least one of a language preference, a security access policy of the client, a font setting, or a color setting.

6. The method of claim 4, further comprising:
providing a directory displayable in the browser; and
enabling a user to transfer a file from the client into the directory.

7. The method of claim 6, wherein the directory enables access to files on the client.

8. The method of claim 6, wherein enabling the user to copy or move the file from the client further comprises:
enabling the user to drag an icon representing the file into the directory, from another directory displayed in a desktop at the client.

9. The method of claim 4, further comprising:
launching, in the browser, using one of the buttons, an application associated with one of the plurality of categories of services.

10. The method of claim 9, further comprising:
saving a file, using the application, into a directory associated with the one of the plurality of categories of services.

11. The method of claim 4, wherein the configuration further includes a location of a central portion of the browser, or a location of a side portion of the browser.

12. The method of claim 4, wherein the menu is movable within the browser.
